(19) United States
(12) Patent Application Publication
(10) Pub. No.: US 2008/0244672 A1
(43) Pub. Date: Oct. 2, 2008

(54) Co-ordinated on-line video viewing

(76) Inventors: Gregory A. Piccionelli, Westlake Village, CA (US); Michael M. Gerardi, Menifee, CA (US)

Correspondence Address: Michael M. Gerardi, Suite 200, 2801 Townsgate Road, Westlake Village, CA, 91361, US

(21) Appl. No.: 12/070,715

(22) Filed: Feb. 20, 2008

Related U.S. Application Data
(60) Provisional application No. 60/902,771, filed on Feb. 21, 2007.

(51) Int. Cl. H04N 7/173; G06F 3/048

(52) U.S. Cl. 725/110; 715/738

(57) ABSTRACT

In a method of co-ordinated on-line data file viewing, a user selects an on-line video or other data file, selects a companion viewer, and views the on-line file simultaneously with the selected companion viewer.

This application is based on U.S. Provisional Patent Application Ser. No. 60/902,771, filed Feb. 21, 2007, the disclosure which is incorporated herein by reference.

### FIELD OF THE INVENTION

The present invention relates to methods for co-ordinated viewing of an on-line video file by two or more viewers.

### BACKGROUND OF THE INVENTION

Video content, whether posted on-line or stored in a storage device such as a DVD, computer hard drive or other storage medium for playback and viewing by a user, is now easily available to users desiring to view the content. With the advent of Internet websites which allow users to post self-produced content and others to view the posted content, for nominal premiums or free of charge, however, professionally-produced video content has become more challenging to monetize.

A need exists for methods of viewing video content which add value to the content and thus are capable of attracting paying customers to view the content.

### SUMMARY OF THE PREFERRED EMBODIMENTS

In accordance with one aspect of the present invention, there is provided a method of coordinated on-line video file viewing that includes the steps of: selecting an on-line video file; selecting a companion viewer; and viewing at least a portion of the on-line video file simultaneously with the selected companion viewer.

It may happen that a selected companion viewer is not available when selected by a user wishing to view a particular on-line video file. Thus, according to more particular embodiments, a companion viewer is selected and it is determined whether the selected companion viewer is available for viewing the on-line video file. When the selected companion viewer is unavailable, an alternative companion viewer is then selected.

Companion viewers are selected in a variety of manners according to specific embodiments of the inventive method. Thus, according to one specific embodiment, a companion viewer is selected from a list of persons associated with the selected video file. Such a list can include, for example, cast members, producers, directors and/or script writers associated with the production of the selected video file, or alternatively, film critics and/or authors who have reviewed the selected video file. According to another specific embodiment, the companion viewer is selected from a list of members of an organization to which a user selecting the video file belongs.

The companion viewer can also be selected, according to a further specific embodiment, from a list of persons presently available to view the video file with a user selecting the video file. In an additional specific embodiment, the companion viewer is automatically selected from a list of companion viewers. The companion viewer can also be selected, according to yet another specific embodiment, from a list of companion viewers generated for a user selecting the video file. The list of companion viewers can also, even more specifically, be separated into a plurality of sub-lists, at which point the user is enabled to select a companion viewer from a sub-list so-generated.

In addition to affording a user desiring to view an on-line video file a listing of potential companion viewers, additional embodiments afford the viewer an opportunity to select an actress or actor appearing in the selected video file as the companion viewer. Thus, according to another particular embodiment, the selected video file, having a plurality of individual frames, is processed such that at least one cast member is identified and located in at least a portion of the individual frames of the video file. In such embodiments, the companion viewer is selected by viewing at least a portion of the selected video file and identifying an on-screen location at which a selected cast member appears. The selected cast member is then notified of the user's selection, and at least a portion of the on-line video file is viewed simultaneously by the user and the selected cast member when the cast member agrees to be the user's companion viewer.

Embodiments of the inventive method allow a user to view the selected on-line video while also viewing images (still or streaming) of the companion viewer. Thus, according to specific embodiments, at least a portion of the on-line video file is viewed in a first window while an image of the companion viewer is displayed in a second window. Similarly, other specific embodiments provide an audio stream from the companion viewer to a user viewing the on-line video file. The audio stream can include, for example, commentary by the companion viewer pertaining to the on-line video file.

Two-way video and/or audio communication between the companion viewer and a user viewing the on-line video (e.g., by means of webcams, video phones or other telecommunication devices) is provided according to further particular embodiments of the inventive method.

Methods according to the invention beneficially afford an opportunity for revenue generation. Thus, according to particular embodiments, a premium is assessed for viewing the on-line video file with the companion viewer.

Other file formats in addition to video files (for example, files containing still images) can be jointly viewed in accordance with another aspect of the present invention.

Other features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is a flowchart illustrating a general viewing method according to the invention,

FIG. 2 is a flowchart illustrating an embodiment of a viewing method of the invention in which a viewer selects a companion viewer who views the video file while simultaneously providing commentary on the video file, and

FIGS. 3a-d are schematic illustrations of an embodiment of the inventive method in which an actress in a video file viewed by a user communicates with the user and provides commentary on the video while the user views the video file.

Like numerals refer to like parts throughout the several views of the drawings.

### DETAILED DESCRIPTION OF THE PREFERRED EMBODIMENTS

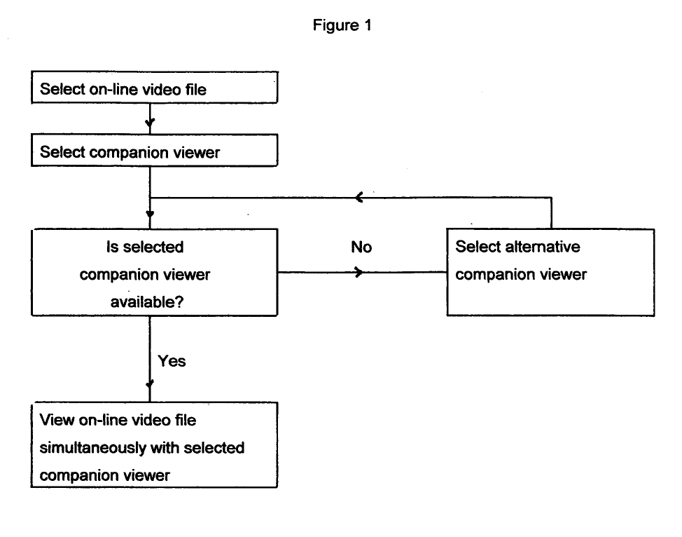

Referring to FIG. 1, a user first accesses a site on a network, such as an Internet website, which offers access to video files for viewing. Such video files can be full-length movies, segments or clips from full-length movies, short features, or any other desired form of video content. The user can access the site without charge, or in more specific embodiments can pay a fee or provide some other exchange of value (such as purchase of a membership in the site) in order to access the site.

Once the user accesses the site, he is presented with a page including a listing of video files available for viewing. The user selects a video file he desires to view from the listing, for example by clicking on the name of the video file, typing the name of the video file in a space provided, or by any other selection means. Upon selection of a video file for viewing, the user is presented with a list of potential companion viewers. These potential companion viewers have made themselves available to view the selected video file on-line simultaneously with users who choose them.

As used herein, a “companion viewer” is a person who views a video file on-line simultaneously with a user while being personally present at a location other than the user's location.

Listings of potential companion viewers for a particular video file can be assembled in various ways. For example, an organization that promotes simultaneous on-line viewing of video files by two or more of its members can enable its members to submit their names for listing with some or all of the available video files offered for viewing by accessing the organization's website. A user-member then selects another member with whom he desires to view the video file.

Alternatively, a listing of cast members, producers, directors, script writers and other persons associated with the production of a particular video file can be provided. A user then selects one of the listed persons with whom he desires to view the video file. Additional persons not directly associated with the production of the video file, such as film critics, authors, and the like who have reviewed the video file, can also be listed if desired.

In more specific embodiments, only potential companion viewers who are presently available and ready to view the selected video are listed or otherwise selectable by the user.

The listing of potential companion viewers can be provided in various forms, such as windows or pop-up menus. Alternatively, the user can be directed to a second page that includes the listing. The listing can also be presented together with thumbnail photos or other depictions of the listed persons, if desired.

Once the user selects a desired companion viewer, the person so selected is notified of the user's selection. Notification can be via cellular telephone or other telecommunications device, via e-mail or other on-line notification method, or by any other desired means. If the selected companion viewer is for some reason unavailable when selected, or does not wish to view the video file with the user for some reason, the user, in some embodiments, is notified of the unavailability and given the opportunity to select an alternative companion viewer.

When an available companion viewer has been selected and has agreed to view the video file with the user, viewing of the video file can commence. In certain embodiments, the user is directed to another page that includes a window for viewing the video file. In other embodiments, a viewing window is included on the same page that includes the listing of potential companion viewers. Any other desired viewing configuration can also be employed.

Desirably, the user is presented with a page that includes not only a window for viewing the selected video file, but also a second window in which a live image of the selected companion viewer is presented. The live image can be transmitted by various means, including a webcam, a camera phone, or any other device capable of transmitting images of the companion viewer. Preferably, the live image is accompanied by an audio transmission, enabling the companion viewer to communicate with the user. In very specific embodiments, the user is likewise enabled to communicate with the companion viewer. This provides the user (and the companion viewer) with a “virtual movie date” experience, as if the user and the companion viewer were actually viewing the video file in person together.

In particular embodiments, the user is charged a premium (for example, a fee per minute of the video file viewed by the user), and in more particular embodiments, at least a portion of the premiums so charged is provided to the selected companion viewer. Thus, the provision of personal interaction with content producers enables the producers to continue to monetize their products.

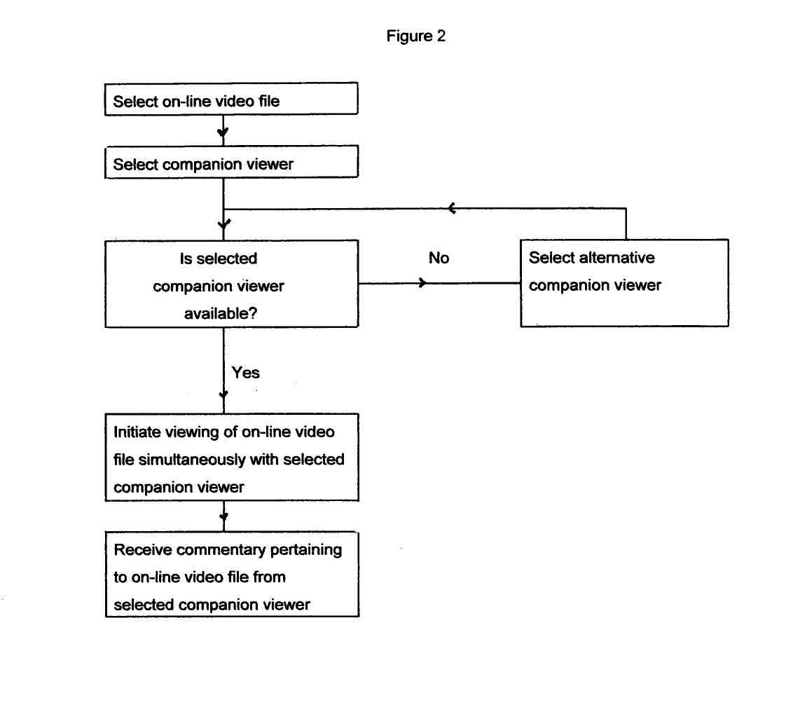

In FIG. 2, a more specific viewing method includes the provision of commentary pertaining to the video file by the selected companion viewer. In this variant, an actress, director or other person associated with the production of the video file can discuss the video file with the user, describe how the video file was produced, provide personal anecdotes about the production, other cast members, her feelings about her participation in the production, and the like. In more specific embodiments, the user can communicate with the companion viewer as well.

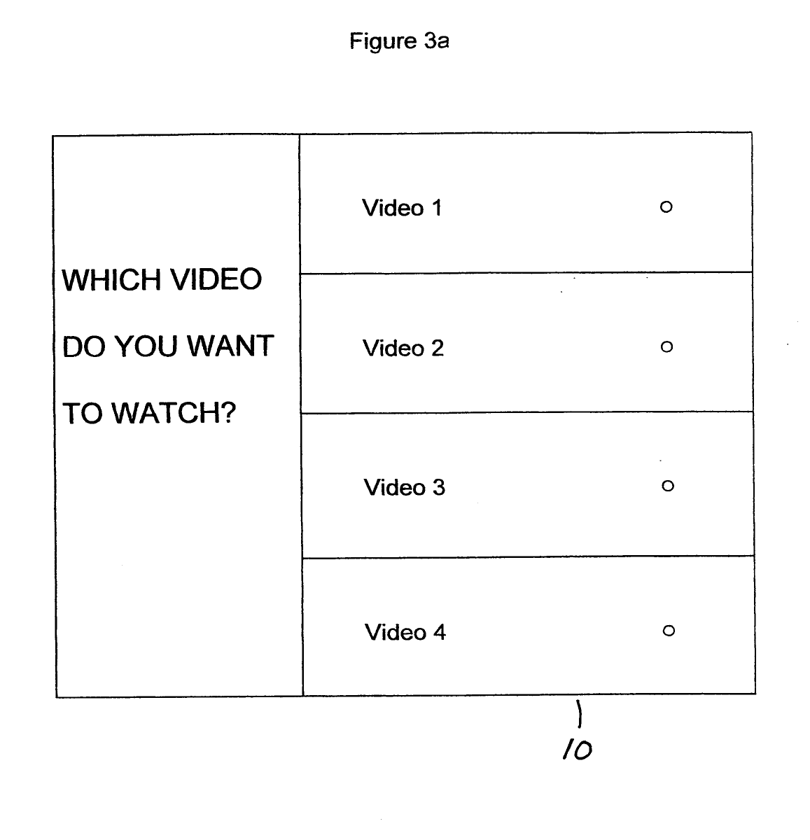

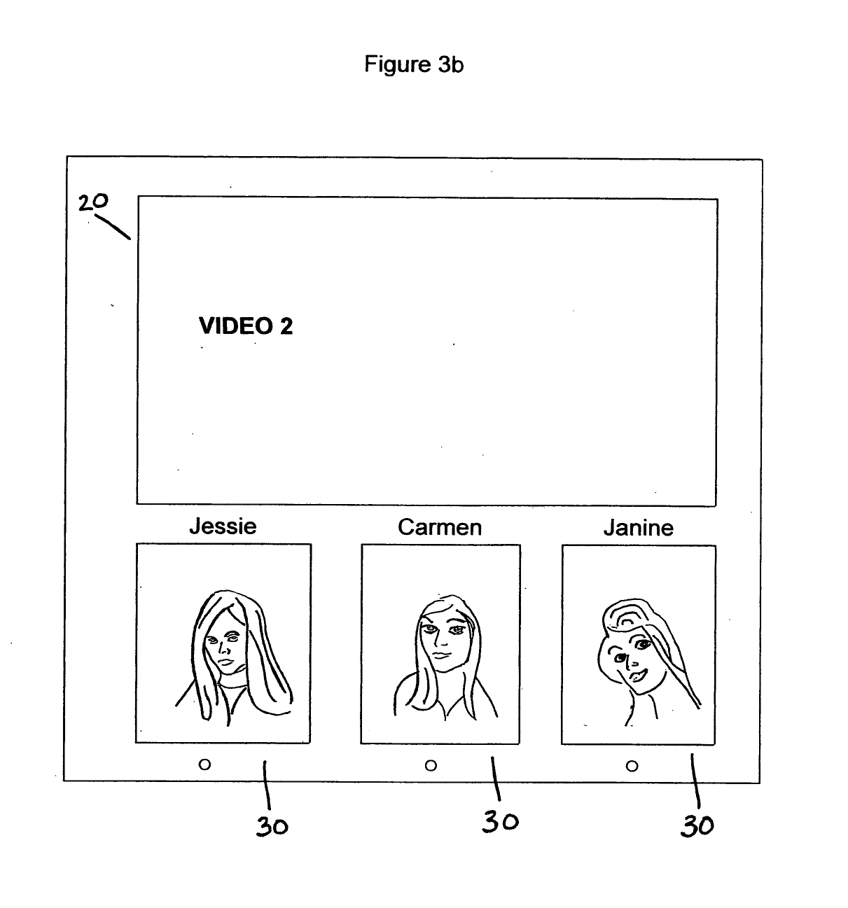

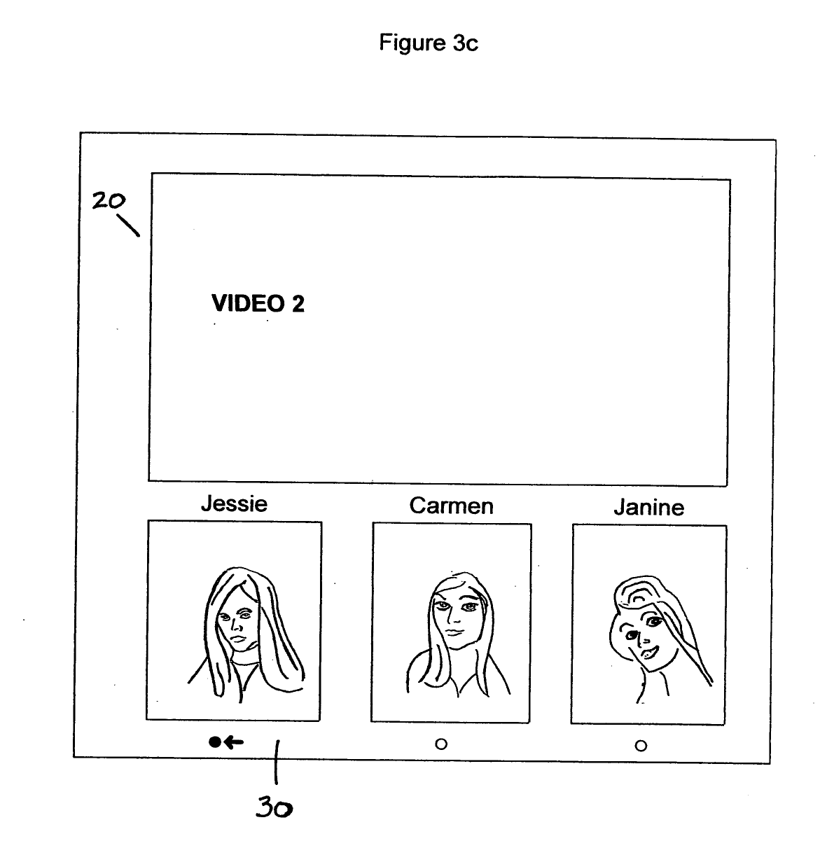

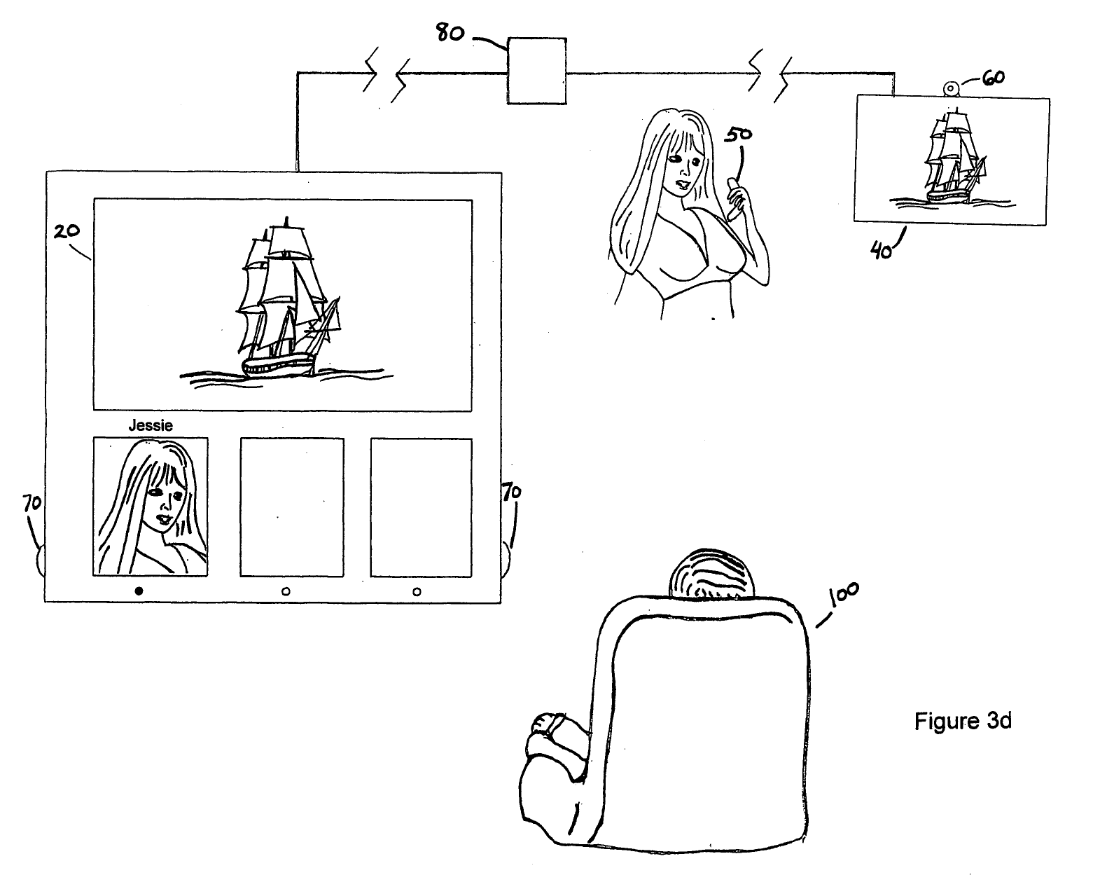

A specific embodiment of the inventive viewing method is illustrated in FIGS. 3a-d. A user 100 first accesses a website 10 offering video files for shared on-line viewing and selects a video file of interest (here, Video 2) (FIG. 3a). The user is directed to another page, which includes a viewing window 20, and a plurality of thumbnail images 30 of potential companion viewers who are presently available for viewing the video file with the user. For example, cast members Jessie, Carmen and Janine are presented as presently available (FIG. 3b).

The user selects cast member Jessie, and clicks on her thumbnail image. The user's request is transmitted to Jessie, for example via a central site such as a server 80 maintained by an organization that provides the video files for viewing. The request is received, for example, on a computer 40, a camera phone 50, or on any other communications device. Jessie then agrees to participate in viewing the video file with the user.

At that point, the selected video file is presented in viewing window 20. At the same time, another window opens on the same page (e.g., replacing the previous thumbnail image), and Jessie's image is transmitted to the user 100, via camera phone 50, webcam 60 or any other image transmission device. She also provides commentary pertaining to the video file while it is being presented for viewing (for example, on computer 40), and the user receives her commentary via speaker 70 or equivalent device. If an image transmission device is also available to the user, he can, in specific embodiments, transmit his image to Jessie as well. Likewise, audio communication is established between the user and Jessie.

The user views the video file simultaneously with the companion viewer for as long as desired, or as long as the selected companion viewer is available or desires to continue viewing the video file. For each viewing period (e.g., each minute), a premium is assessed to the user, and a portion of the premium so assessed is provided to the companion viewer.

Additional embodiments of the inventive method provide for alternative procedures for identifying and selecting companion viewers. As described above, the user can be presented with a listing of companion viewers who are presently available. This listing can include companion viewers who have previously contacted the website host and notified the host of their availability for a stated period of time, and optionally also with respect to one or more specific videos. The companion viewers can also provide the website host with a schedule of times during which they will be available for viewing one or more videos. When a user desires to view a selected video, the website generates a listing of available companion viewers for the selected video based on the schedules and other information so submitted.

Alternatively, potential companion viewers can place themselves on a contact list; if they are selected by a user, they agree to be contacted, typically by the website host after a user selects them, to determine if they are available for viewing. If they are not available (e.g., they are busy, they don't wish to participate, etc.), then the user can be advised to make another selection. If no companion viewers prove to be available for the selected video, the user can be advised to select another video.

In additional embodiments, the website provides a general list of companion viewers, i.e., viewers who are always “on call” to view the selected video, or some or all of the videos available from the website, with users. These companion viewers can be performers, producers, etc., or members of an organization associated with the website. In the latter case, the user can also be a member, and thus place himself or herself on the general list if desired.

The user can also be given the option of authorizing the website to select a companion viewer from a list of potential viewers (who may or may not be presently available). In this embodiment, the website then automatically checks the list, for example, in the companion viewers' listed order, or randomly, until an available companion viewer is found.

Alternatively, the website generates a list of companion viewers specifically for the user. In this embodiment, the website locates a selected number of available companion viewers (e.g., 5, 10, 20, etc.) from a list of potential companion viewers, and then presents the user with the generated list and enables the user to make a selection. (Depending on the number of companion viewers to be listed, the user can be advised that the selection procedure may take a substantial length of time if multiple individuals need to be contacted). More particularly, the website generates a list of potential companion viewers, and then sorts them into sub-lists according to various selection criteria. Such criteria can include, without limitation: fans of a particular actress in the selected video; fans of another cast member in the selected video; fans of a specific video genre (action, comedy, romance, etc.), in particular the genre of the selected video; previous viewers of the selected video; performers in the genre of the selected video; performers who have performed with one or more of the cast members of the selected video; etc. The user is then enabled to select a companion viewer from a sub-list so generated.

In addition to selecting from a list of potential companion viewers, alternative embodiments of the inventive method enable a user to select a companion viewer directly from a selected video. In these embodiments, the website host first processes videos available for viewing such that one or more cast members are identified and located in individual frames of the videos (by means of image-recognition software or other means). For example, Jessie is located in a frame of a video, and her location is identified, together with a range of pixels from her location (e.g., 25 pixels). This processing is repeated for each frame in which she appears in the video. When a user selects and begins viewing a video, he clicks within the selected range of pixels from Jessie's location on-screen at some point. The user's click thus selects Jessie as the user's desired companion viewer. Jessie is then contacted, e.g., by the website host via cell phone or any other communications device, to determine if she is available for viewing. If she agrees, the user is notified and the viewing process initiates.

Once a companion viewer has been selected and contacted, and agrees to view the video with the user, a viewing protocol is typically selected. For example, the companion viewer can select to participate via a webcam located at her home or business; via a portable device such as a camera phone; or via any other device that is capable of transmitting visual and audio information to the user.

Although the invention has been described in terms of viewing video files, other data files, for example, files containing a series of still images such as photographs, can also be viewed.

What is claimed is:

1. A method of coordinated on-line video file viewing comprising the steps of:
a) selecting an on-line video file,
b) selecting a companion viewer, and
c) viewing at least a portion of the on-line video file simultaneously with the selected companion viewer.

2. The method of claim 1 wherein in step b) a companion viewer is selected and it is determined whether the selected companion viewer is available for viewing the on-line video file.

3. The method of claim 2 wherein an alternative companion viewer is selected when the selected companion viewer is unavailable.

4. The method of claim 1 wherein in step b) a companion viewer is selected from a list of persons associated with the selected video file.

5. The method of claim 4 wherein the list comprises a plurality of persons selected from the group consisting of cast members, producers, directors and script writers associated with the production of the selected video file.

6. The method of claim 4 wherein the list comprises a plurality of persons selected from the group consisting of film critics and authors who have reviewed the selected video file.

7. The method of claim 1 wherein in step b) a companion viewer is selected from a list of members of an organization to which a user selecting the video file belongs.

8. The method of claim 1 wherein in step b) a companion viewer is selected from a list of persons presently available to view the video file with a user selecting the video file.

9. The method of claim 1 wherein in step b) a companion viewer is automatically selected from a list of companion viewers.

10. The method of claim 1 wherein in step b) a companion viewer is selected from a list of companion viewers generated for a user selecting the video file.

11. The method of claim 10 wherein the a list of companion viewers is separated into a plurality of sub-lists and the user is enabled to select a companion viewer from a sub-list so-generated.

12. The method of claim 1 wherein the selected video file having a plurality of individual frames is processed such that at least one cast member is identified and located in at least a portion of the individual frames of the video file and wherein in step b) the companion viewer is selected by viewing at least a portion of the selected video file and identifying an on-screen location at which a selected cast member appears.

13. The method of claim 12 wherein the selected cast member is notified of the user's selection and wherein in step c) at least a portion of the on-line video file is viewed simultaneously by the user and the cast member when the cast member agrees to be the user's companion viewer.

14. The method of claim 1 wherein in step c) at least a portion of the on-line video file is viewed in a first window while an image of the companion viewer is displayed in a second window.

15. The method of claim 1 wherein in step c) at least a portion of the on-line video file is viewed while an audio stream is transmitted from the companion viewer to a user viewing the on-line video file.

16. The method of claim 15 wherein in step c) video communication between the companion viewer and the user is established.

17. The method of claim 15 wherein in step c) audio communication between the companion viewer and the user is established.

18. The method of claim 1 wherein in step c) a premium is assessed.

19. A method of coordinated on-line data file viewing comprising the steps of:
a) selecting an on-line data file,
b) selecting a companion viewer, and
c) viewing the on-line data file simultaneously with the selected companion viewer.
